(19) United States
(12) Patent Application Publication
(10) Pub. No.: US 2026/0369173 A1
(43) Pub. Date: Nov. 19, 2026

(54) SYSTEMS AND METHODS FOR DETERMINING LANDING REQUIREMENTS FOR LANDING AN AIRCRAFT SYSTEM

(71) Applicant: Jeppesen ForeFlight, Inc., Englewood, CO (US)

(72) Inventors: Marko Zoricic, Dreieich (DE); Frank Mario Hempel-Ettelt, Seligenstadt (DE); Mateusz Adamski, Rumia (PL)

(73) Assignee: The Boeing Company, Arlington, VA (US)

(21) Appl. No.: 19/210,493

(22) Filed: May 16, 2025

(51) Int. Cl. G08G 5/54; G08G 5/26

(52) U.S. Cl. CPC G08G 5/54; G08G 5/26

(57) ABSTRACT

A system and method for determining landing requirements for landing an aircraft system include detecting a user selection by an operator that identifies a location where an aircraft system is to land. The user selection is associated with a first set of data. The first set of data stored within a database is received and a second set of data is accessed. The second set of data includes one or more regulatory requirements associated with the user selection. The first set of data is analyzed relative to the second set of data with one or more processors to determine one or more landing requirements for the aircraft system. The landing requirements are transmitted to the aircraft system and the aircraft system is controlled to land at the landing location according to the one or more landing requirements.

### BACKGROUND

### Field of the Disclosure

The present disclosure relates to a system and a method for automatically determining one or more landing requirements for an aircraft system.

### Description of the Art

In the aviation industry, aircrafts may be required to follow one or more landing procedures in order to safely land the aircraft. The landing procedures may include minimum altitudes that the aircraft may be allowed to descend to at one or more locations surrounding a landing location (e.g., an airport), may include minimum visibility requirements that the pilot must meet, etc. The landing procedures may be based on regulatory requirements, may be based on approach lighting systems and other landing infrastructures in place at various airports, may be based on software and/or hardware system capabilities of the aircraft system itself (e.g., older aircraft systems may not be equipped with updated instrument landing systems, etc.), or the like.

In particular, for each landing operation, pilots must be required to have a certain level of visibility of the landing location at a determined distance away from the landing location before the aircraft is allowed to descend to a location below a minimum altitude requirement. For example, a pilot must have visibility of an approach lighting system or a runway at least 750 meters away from the runway before the aircraft is allowed to descend to an altitude of 491 feet. If the pilot does not have visibility 750 meters away from the runway, then the aircraft is prohibited from descending below the minimum altitude, and the pilot may need to abort the landing procedure to circle back and try again, or to attempt to land at another location.

The landing minimums that are calculated, however, can vary based on numerous factors, including the location of the airport, based on the type or classification of the aircraft system, based on governing landing procedures of the aircraft system and/or the airport, or the like. As another example, the landing minimums may vary at different times throughout a day, such as based on infrastructure changes at the airport (e.g., changes to an approach lighting system), based on a level of air-traffic congestion surrounding the airport, or the like.

Some known methods for calculating landing minima, however, are done so manually by individual technicians analyzing source-provided data and following specific steps outlines in minima specifications. This manual approach has several drawbacks, including being susceptible to errors, can result in minima calculations that vary from one technician to another, has limited efficiency, and is difficult to adapt to changes in regulatory requirements.

### BRIEF SUMMARY

In one example, a method for determining landing requirements for landing an aircraft system is provided. The method involves detecting a user selection by an operator that identifies a location where an aircraft system is to land. The user selection is associated with a first set of data. The first set of data stored within a database is received and a second set of data is accessed. The second set of data includes one or more regulatory requirements associated with the user selection. The first set of data is analyzed relative to the second set of data with one or more processors to determine one or more landing requirements for the aircraft system. The landing requirements are transmitted to the aircraft system and the aircraft system is controlled to land at the location according to the one or more landing requirements.

In another example, a system for automatically determining landing requirements for an aircraft system is provided. The system includes an input device that receives a user selection by an operator that identifies a location where the aircraft system is to land and is associated with a first set of data that is stored within a memory. A controller receives the first set of data and accesses a second set of data. The second set of data includes one or more regulatory requirements associated with the user selection. The controller analyzes the first set of data relative to the second set of data to determine one or more landing requirements for the aircraft system. The controller prompts the transmission of the landing requirements to the aircraft system and the aircraft system is controlled to land at the location according to the landing requirements.

In another example, a non-transitory computer-readable storage medium comprising executable instructions that, in response to execution, cause one or more control units comprising one or more processors to perform the operations described herein. The operations involve detecting a user selection by an operator that identifies a location where an aircraft system is to land. The user selection is associated with a first set of data stored within a database. The first set of data is received and a second set of data, including one or more regulatory requirements associated with the user selection, is accessed. Responsive to identifying that at least some information is missing from the first set of data, a third set of data is received. The third set of data is combined with the first set of data. The first set of data is analyzed relative to the second set of data and the third set of data to determine one or more landing requirements for the aircraft system. The landing requirements are transmitted to the aircraft system and the aircraft system is controlled to land at the location according to the landing requirements.

### BRIEF DESCRIPTION OF THE DRAWINGS

FIG. 1 illustrates a schematic of a system for determining landing requirements, according to one example of the present disclosure.

FIG. 2 illustrates a flow chart of method for determining landing requirements for an aircraft system, according to one example of the present disclosure.

FIG. 3 illustrates a first graphical example of a display of landing requirements, according to one example of the present disclosure.

FIG. 4 illustrates a second graphical example of a display of landing requirements, according to one example of the present disclosure.

### DETAILED DESCRIPTION

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

In the realm of flight management, there is a growing need for an automated process of calculating landing minima. The present methods and systems address these challenges by providing a system that examines multiple different sets of data, automatically calculating minimum altitude and visibility requirements based on numerous real-time factors. The methods and systems incorporate standardized algorithms and data sources, ensuring consistent and uniform calculations, offers improved efficiencies in completing the calculations, reduces safety risks by minimizing the potential for errors that may be present in manual data entries and calculations, and provides a streamlined workflow that may be seamlessly integrated into a production process that may be used directly by technicians or other operators.

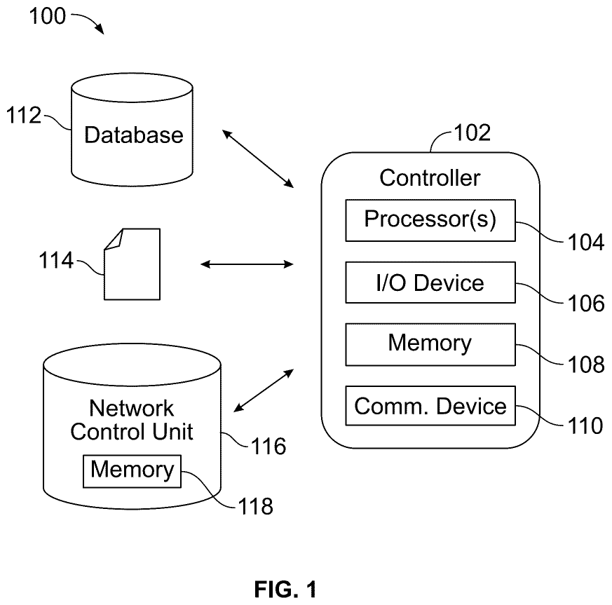

FIG. 1 illustrates a schematic of one example of a system 100 for determining landing requirements for landing an aircraft system. In one or more examples, the system 100 may be utilized by an operator (e.g., a dispatch operator at an airline control center, an air traffic control operator, a pilot, or the like) to determine one or more landing requirements. For example, the system 100 may receive one or more user inputs from an operator, and based on the user inputs, may automatically determine one or more landing requirements for landing the aircraft system.

In one or more examples, the landing requirements may specify one or more minimum altitude or height requirements (e.g., a level or distance above a ground level) at which the pilot of the aircraft system is to have a sufficient amount of visibility (e.g., of a runway, of an approach lighting system at the landing location, or the like) for the pilot to land the aircraft system. For example, the pilot may be required (e.g., based on one or more governmental regulatory requirements, requirements specified by a manufacturer of the aircraft system, requirements specified by an owner of the aircraft system, or the like) to have a certain level of visibility of the approach lighting system at a determined distance away from the landing location at a calculated minimum altitude for the pilot to be allowed to land the aircraft system. If the pilot does not have visibility (e.g., of the approach lighting system) at the determined distance away from the landing location, then the pilot may be prohibited from moving to an altitude that is less than (e.g., closer to a ground level) the minimum altitude.

As one example, the pilot may need to control the aircraft system to abort landing of the aircraft system and circle back around to attempt a second landing operation if the pilot is unable to meet the runway visual range visibility requirements at the calculated minimum altitude. As another example, the pilot may need to abort the landing procedure at the landing location and land the aircraft system at a different landing location. For example, the planned landing location may be experiencing ambient weather conditions that hinder the visibility of the pilot.

The system 100 includes a controller 102 having one or more processors 104. The one or more processors 104 can represent various types of processors, each suited to handle the complex computations required for real-time data processing and machine learning tasks. Examples of different processors that the controller 102 can include and/or represent include one or more central processing units (CPU), graphics processing units (GPU), field-programmable gate arrays (FPGA), application-specific integrated circuits (ASIC), digital signal processors (DSP), tensor processing units (TPU), or the like.

The controller 102 includes an input/output device 106 (shown as “I/O Device” in FIG. 1) that may provide an interface that allows an operator of the system 100 to interact with the controller 102. The I/O device 106 can represent a keyboard, a headset, a microphone, an electronic mouse, a stylus, a speaker, a light, a display screen, an electronic monitor, a television, a touchscreen, or the like. Additionally, the controller may communicate with the operator, such as by displaying information on a display screen to the operator, may output an audio and/or visual alert to the operator, or the like. In one example, the I/O device 106 can represent one or more different devices that may be integrated within or associated with a computer workstation, a single touchscreen interface, a handheld device (e.g., a smartphone, a smart tablet, or the like), or the like.

In one or more examples, the operator may utilize the I/O device 106 to communicate a command to the processors 104 that may be detected by the controller 102. The command or user input may provide information to the processors 104. In one example, the command or user input may be a selection by the operator that identifies a geographic location where the aircraft system intends to land (e.g., an airport, a runway strip, or the like). Optionally, the user selection may specify, identify, and/or be based on a classification of the aircraft system (e.g., a make, a model, a type, a year, or the like). Optionally, the user selection may specify one or more systems onboard the aircraft (e.g., is the aircraft system is equipped with an instrument landing system, or the like).

The controller 102 also includes a communication device 110 that can include or represent one or more antennas, transceivers, radios, communication networks (e.g., private and/or public internet communications), and/or the like. The communication device 110 may allow the controller 102 to communicate with other devices or systems, such as a remote database 112, a network control unit 116, one or more aircraft systems (not shown), an air-traffic control system (not shown), or the like, via one or more wired and/or wireless communication links.

The controller 102 is configured to execute a set of instructions that are stored in one or more of a memory 108 or one or more other data storage units or elements in order to process data. The memory 108 may also store data or other information as desired or as needed. The memory 108 may be in the form of an information source or a physical memory unit within the controller 102. For example, the memory 108 can represent various types of computer memory, such as read-only memory (ROM), flash memory, one or more solid-state drives (SSD), hard disk drives (HDD), network-attached storage (NAS), or the like.

The set of instructions may include various commands that instruct the controller 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine, such as the network control unit 116 associated with the system 100.

In one or more examples, the set of instructions may be associated with calculating one or more landing requirements for landing the aircraft system. The landing requirements may include a minimum altitude requirement, a minimum visual or visibility requirement, or the like. The controller 102 may receive data from one or more sources with which the landing requirements may be calculated.

The memory 108 may store a first set of data that may be accessed and used by the controller 102 to determine the landing requirements. Additionally or alternatively, the controller 102 may interface with one or more of the remote databases 112 may represent a cloud-based data system that may store data accessible to the controller 102. The remote database(s) 112 may store or maintain at least some of the first set of data that may be accessible by the processors 104.

The first set of data may include and/or be associated with one or more systems, structures, and/or conditions of the landing location. For example, the first set of data may include, but is not limited to, landing procedures, approach lighting systems (ALS) of the landing location, (e.g., a length of the ALS; a type, classification, or arrangement of the ALS; a change to the ALS, or the like), radio frequency channels associated with the landing location (e.g., approach communication channels, air traffic control tower communication channels, etc.), an airport elevation and/or a runway elevation, current ambient conditions at the landing location (e.g., ground speed wind levels, ambient temperatures, ambient humidity levels, rain, snow or sleet conditions, etc.), or the like. As one example, the ALS of the landing location may include a temporary extension component, such as a crane or other device, that may change an elevation of one or more lights of the lighting system. The temporary extension component may be in an extended position at one or more times throughout a day, a week, a month, or the like, or may be in a retracted position at one or more other times.

In one example, the controller 102 may access, receive, or otherwise obtain at least some data from the network control unit 116, that may represent a centralized network system that is utilized by numerous controllers associated with a common entity, such as an airline. For example, the illustrated example of FIG. 1 includes a single controller 102 that is communicatively coupled with the network control unit 116, but the network control unit 116 may also be communicatively coupled with numerous other controllers (not shown) associated with the common airline. For example, each of the numerous controllers may be capable of providing and accessing data stored within a memory 118 of the network control unit 116. In another example, the network control unit can represent an air-traffic controller (e.g., at a particular landing location), a maintenance center, or the like.

The memory 118 of the network control unit 116 may store a second set of data that may be accessibly by the processors 104. Additionally or alternatively, all or a portion of the second set of data may be stored within the memory 108. In one or more examples, the second set of data may be associated with one or more regulatory requirements associated with the landing location, landing procedures associated with the landing location, landing procedures associated with the type or classification of the aircraft system, or the like. For example, the second set of data may include regulatory requirements that may be governmental requirements (e.g., directed by a geographic region in which the landing location is located), industry regulatory requirements, procedure requirements dictated by the landing location, requirements specified by a manufacturer of the aircraft system, requirements specified by an owner of the aircraft system (e.g., an airline company), or the like.

In one or more examples, the controller 102 may need to calculate landing requirements for an aircraft system. As one example, the calculation of the landing requirements may be initiated by the operator of the system 100. For example, the operator of the system 100 may communicate a user selection with the controller 102 via the I/O device 106 to initiate the process. The user selection may identify a location where the aircraft system intends to land (e.g., an airport, landing strip, runway, or the like). As another example, the calculation may be initiated by a pilot of the aircraft system requesting the landing requirements. As another example, the calculations may be initiated responsive to one or more changes at the landing location, responsive to one or more changes to the regulatory requirements, or the like. For example, the controller 102 may identify that there have been one or more changes to regulatory requirements or physical changes to the landing location, and the controller may output a command message to the operator via the I/O device 106 requesting that the operator input a user selection.

Responsive to receiving or detecting the user selection, the controller 102 may access or receive the first set of data from the memory 108 and/or the remote database(s) 112, and the second set of data from the network control unit 116. The first set of data and the second set of data may be based on or associated with the user selection that is received. The controller 102 may automatically analyze, examine, manipulate, or the like, the first set of data relative to the second set of data to automatically determine the landing requirements, such as without operator input. For example, the circuits of the controller 102 may be configured to execute one or more algorithms to examine the first and second sets of data in order to determine the one or more landing requirements.

In one or more examples, the controller 102 may determine that some information is missing from the first set of data, may identify the particular or specific information that is missing from the first set of data, or the like. The controller 102 may communicate to the operator the information that is determined to be missing from the first set of data, and may request a third set of data, such as from a third source 114. As one example, the third source 114 may represent data that may be manually provided by the operator of the system 100. As another example, the third source 114 may represent another cloud-based data storage system. The third set of data may be combined with the first set of data to provide a complete data set. For example, the third set of data may represent the information that is missing from the first set of data. The controller 102 may automatically analyze, examine, manipulate, or the like, the first set of data relative to the second and third sets of data to automatically determine the landing requirements for the aircraft system.

Responsive to determining the one or more landing requirements, the controller 102 may automatically initiate transmission of the landing requirements, such as to the pilot of the aircraft system, to multiple aircraft systems that are planning to land at the landing location, to an air-traffic control system, or the like. The landing requirements may be automatically transmitted via one or more wireless communication links between the communication device 110 and the receiving entity. As one example, the controller 102 may communicate the landing requirements to an instrument landing system of the aircraft system, and the aircraft system may be automatically controller to land at the landing location according to the landing requirements. As another example, the controller 102 may be communicatively coupled with an electronic flight bag of the aircraft system, that may automatically display and/or communicate the landing requirements to the pilot of the aircraft system. The pilot may control operation of the aircraft system in order to land the aircraft system at the landing location while adhering to the landing requirements. As another example, the controller 102 may be communicatively coupled with the air-traffic control tower, that may display and/or communicate the landing requirements with an air-traffic control operator, which may be relayed to the pilot of the aircraft system and/or relayed to plural aircraft systems intending to land at the landing location.

In one or more examples, the landing requirements may need to be calculated or re-calculated, multiple times a day, multiple times an hour, or the like. As another example, the landing requirements may need to be calculated or re-calculated for specific times throughout the day, such as in response to changes with the approach lighting system at the landing location. For example, the approach landing system may include additional light features or elements that may only be used for a given time throughout the day (e.g., a predetermined number of hours), and may not be used outside of the given times. The landing requirements may change based on whether or not the additional light features are being used or are not being used.

The controller 102 may determine the landing requirements substantially instantaneously (e.g., within a few seconds) with the detection of the user selection. For example, the controller 102 may be capable of calculating the landing requirements at a rate that a human being would be incapable of achieving. By calculating the landing requirements at an improved speed relative to a human operator, the controller 102 can provide the accurate landing requirements to a pilot of the aircraft system in a more efficient manner.

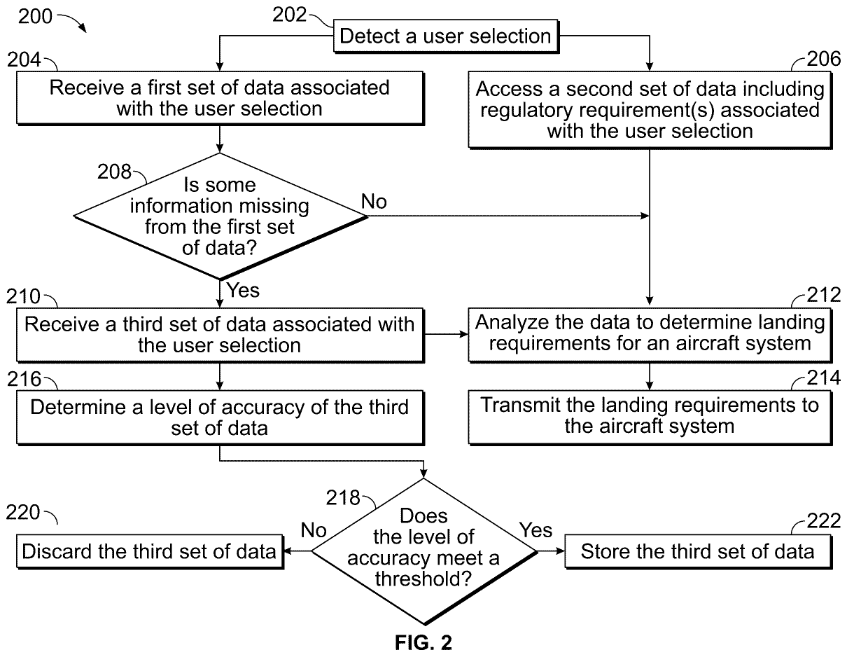

FIG. 2 illustrates a flowchart 200 of one example of a method of automatically determining landing requirements for landing an aircraft system. At 202, a user selection is detected, such as by the controller 102. The user selection may be an input by an operator of the system via the I/O device 106. The user selection may identify a location where the aircraft system is scheduled to or is planning to land (e.g., an airport, a landing strip, etc.). Optionally, the user selection may identify or be associated with a type or classification of the aircraft system (e.g., a make, a model, a year, an identification of instrumental systems onboard the aircraft, or the like).

At 204, a first set of data is accessed, received, or otherwise obtained. The first set of data may be associated with landing procedures, the approach lighting system (ALS) of the landing location, (e.g., a length of the ALS; a type, classification, or arrangement of the ALS; changes to the ALS, or the like), radio frequency channels associated with the landing location (e.g., approach communication channels, air traffic control tower communication channels, etc.), an airport elevation and/or a runway elevation, current ambient conditions at the landing location (e.g., ground speed wind levels, ambient temperatures, ambient humidity levels, rain, snow or sleet conditions, etc.), or the like. Optionally, the first set of data may be associated with one or more systems onboard the aircraft system (e.g., instrument landing systems, positioning systems, landing gear of the aircraft system, a wing-span of the aircraft system, a propulsion and/or braking system of the aircraft system, or the like).

At 206, a second set of data is accessed, received, or otherwise obtained. The second set of data may be associated with regulatory requirements and/or changes within the regulatory requirements. The regulatory requirements may be governmental requirements (e.g., directed by a geographic region in which the landing location is located), regulatory requirements, requirements specified by a manufacturer of the aircraft system, requirements specified by an owner of the aircraft system (e.g., an airline company), or the like. In one or more examples, the regulatory requirements may be associated with the user selection (e.g., the landing location and/or the type or classification of the aircraft system). For example, different landing locations may have different regulatory requirements that aircraft systems may need to follow, adhere to, or abide by while landing at the different landing locations.

At 208, a determination is made if there is any information that may be missing from the first set of data. For example, the first set of data may be determined to be incomplete, such that the controller 102 may require additional or alternative information in order to determine the landing requirements. If it is determined that the first set of data is complete (e.g., the controller 102 has accessed all information that is needed to determine the landing requirements), flow of the method proceeds toward 212.

Alternatively, if it is determined that at least some information is missing from the first set of data, flow of the method proceeds toward 210. At 210, a third set of data is accessed, received, or otherwise obtained, such as from the third source 114. In one example, the third source 114 may represent an operator that manually provides the third set of data to the system. In another example, a remote database may represent the third source 114 that may automatically provide the third set of data to the controller 102. The third set of data may include the information that was determined to be missing from the first set of data, such that the third set of data is combined with the first set of data to provide a completed first set of data.

At 212, the processors 104 of the controller 102 may automatically analyze, examine, or manipulate the data (e.g., the first set of data, the second set of data, and optionally the third set of data) in order to determine the one or more landing requirements for the aircraft system. The landing requirements may include an altitude requirement and/or a visual requirement. For example, the landing requirements may specify a minimum altitude the aircraft system may reach (e.g., relative to an airport elevation and/or a runway elevation) and/or a level of visibility (e.g., of an approach lighting system, of a runway, or the like) that the pilot must have in order for the pilot to be allowed to land the aircraft system at the landing location. For example, if the pilot does not have the level of visibility determined by the landing requirements when the aircraft system reaches the minimum altitude calculated by the controller 102, the pilot may be prohibited from landing the aircraft system at the landing location. Alternatively, if the pilot does have the level of visibility determined by the landing requirements when the aircraft system reaches the minimum altitude, the pilot may proceed with landing the aircraft system.

At 214, the landing requirements may be transmitted to the aircraft system. For example, the landing requirements may be automatically transmitted to the aircraft system via the communication device 110, may be transmitted to the aircraft system by way of a communication link between an air-traffic control system communicatively coupled with the controller 102 and the aircraft system, or the like. In one example, the landing requirements may be displayed to the operator of the controller 102, to the pilot of the aircraft system, to an air-traffic controller, or the like. Optionally, the landing requirements may be transmitted to one or more other aircraft systems, such as other aircraft systems that intend to land at the landing location. The aircraft system may be controlled to land at the landing location according to the landing requirements. For example, the aircraft system may be automatically controlled, such as by one or more control systems onboard the aircraft system, or may be manually controlled, such as by the pilot, to land according to the landing requirements.

Returning to step 210, responsive to the receiving of the third set of data, flow of the method may also proceed toward 216. At 216, a level of accuracy of the third set of data is determined. In one example, an operator may manually review the third set of data and determine a level of accuracy of the third set of data, and if the level of accuracy meets or exceeds a predetermined designated accuracy threshold. The operator reviewing the accuracy level of the third set of data may be a different operator than the operator that manually input the third set of data. Optionally, the accuracy level of the third set of data may be automatically examined and/or determined by the processors 104, such as by comparing the third set of data with a standard data set. Optionally, the accuracy level may be examined by another processing system, another control system, or the like.

At 218, a determination is made if the level of accuracy of the third set of data meets or exceeds the predetermined accuracy threshold. If the level of accuracy does not meet the threshold, flow of the method proceeds toward 220, and the third set of data may be discarded. Alternatively, if the level of accuracy of the third set of data meets or exceeds the predetermined accuracy threshold, flow of the method proceeds toward 222. At 222, the third set of data may be stored in a memory or database, such as the memory 108 of the controller 102, within the remote database 112, within the memory 118 of the network control unit 116, or the like. In one or more examples, the third set of data may be stored with all or a portion of the first set of data.

In one or more examples, at least some information within the second set of data may change. As one example, the controller 102 may automatically receive notification that the information has changed. As another example, the operator may manually communicate with the controller 102 that a portion of the information within the second set of data has changed. The controller 102 may receive or access a revised second set of data that includes the information that has changed, and may automatically analyze the revised second set of data with the first set of data (and optionally with the third set of data) in order to determine one or more revised landing requirements, which may be transmitted to the aircraft system for the pilot to land the aircraft system at the landing location in accordance with the revised landing requirements.

In another example, at least some information within the first set of data may change. For example, the lighting system at the landing location may change, ambient conditions at the landing location may change, the landing location may be experiencing an emergency situation, such as with another aircraft system, or the like. In one example, the controller 102 may automatically identify that at least some information within the first set of data has changed. As another example, the controller 102 may receive communication (e.g., from the landing location, from the pilot, from the operator of the system 100, or the like) that some information within the first set of data has changed.

The controller 102 may receive or access a revised first set of data. responsive to at least some information within the first set of data changing, and may automatically examine the revised first set of data relative to the second set of data (and optionally the third set of data) to determine one or more revised landing requirements for the aircraft system.

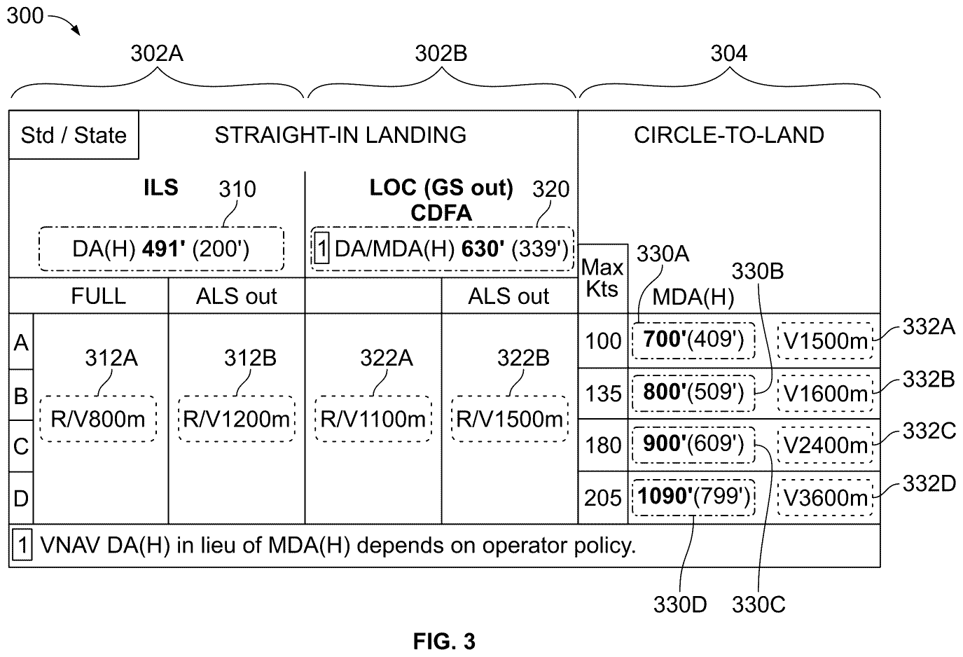

FIG. 3 illustrates a first graphical example of a display 300 of landing requirements, according to one example of the present disclosure. The landing requirements may be displayed to the operator of the system 100, such as via the I/O device 106. Optionally, the landing requirements may be displayed to the pilot of the aircraft system, to plural different pilots operating plural different aircraft systems, to an air-traffic control operator, or the like.

The display 300 includes a first straight-in portion 302A, a second straight-in portion 302B, and a circle-to-land portion 304. The first and second straight-in portions 302A, 302B may provide landing minimums (e.g., altitude and visibility minimums) to the pilot in situations in which the aircraft system is controlled in a straight-in landing. The circle-to-land portion 304 may provide landing minimums (e.g., altitude and visibility minimums) to the pilot in situations in which the aircraft system may need to circle one or more times before landing.

The first straight-in portion 302A may indicate the calculated minimum requirements for aircraft systems that include an instrument landing system. The instrument landing system (ILS) may represent a precision runway approach assistance system that provides the pilot with vertical and horizontal guidance during a landing approach. Alternatively, the second straight-in-portion 302B may indicate the calculated minimum requirements for aircraft systems that do not include an instrument landing system, but instead include a localizer (LOC) that provides azimuth guidance.

The controller 102 may automatically determine individual landing requirements for each of the first straight-in portion 302A and the second straight-in portion 302B based on the systems available to the pilot onboard the aircraft system. For example, the controller may calculate a first minimum altitude landing requirement 310 associated with the aircraft system that includes the ILS, and may calculate a second minimum altitude landing requirement 320 associated with the aircraft system that does not include the ILS. Based on the first set of data, the second set of data, and optionally the third set of data, the controller 102 may automatically calculate the first minimum altitude landing requirement 310 that specifies a decision altitude or height (DA(H)) of 491 feet (200 feet). Based on the first set of data, the second set of data, and optionally the third set of data, the controller 102 may automatically calculate the second minimum altitude landing requirement 320 that specifies a minimum descent altitude or height (MDA(H)) of 630 feet (339 feet). Additionally, based on the first, second, and optionally the third set of data, the controller 102 may automatically calculate plural third minimum altitude landing requirements 330A-D for instances when the aircraft system needs to circle before landing.

Additionally, the controller 102 may automatically determine minimum visibility requirements based on the calculated minimum altitude landing requirements. As one example, the visibility requirements may be defined within a reference table (e.g., stored within the memory 108) based on the minimum altitude requirements. For example, the controller 102 may locate the calculated minimum altitude requirements within a reference table in order to identify the corresponding minimum visibility landing requirements. The first straight-in portion 302A displays a first minimum visibility landing requirement 312A (e.g., 800 meters) and a second minimum visibility landing requirement 312B (e.g., 1200 meters). The second straight-in portion 302B displays a third minimum visibility landing requirement 322A (e.g., 1100 meters) and a fourth minimum landing requirement 322B (e.g., 1500 meters). For example, in an aircraft system that does not include an instrument landing system, and if the approach lighting system is out, the pilot must have visibility of the landing location at a distance of 1500 meters from the landing location before the aircraft system is allowed to descend to an altitude that is less than 630 feet.

Additionally, the controller 102 may determine plural minimum visibility requirements 332A-D for each of the plural third minimum altitude landing requirements 330A-D for instances when the aircraft systems circles before landing.

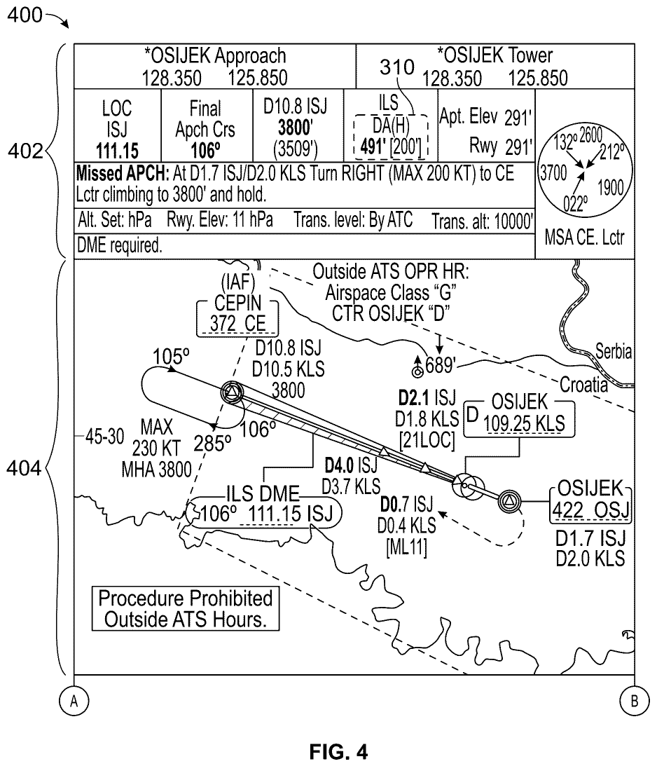

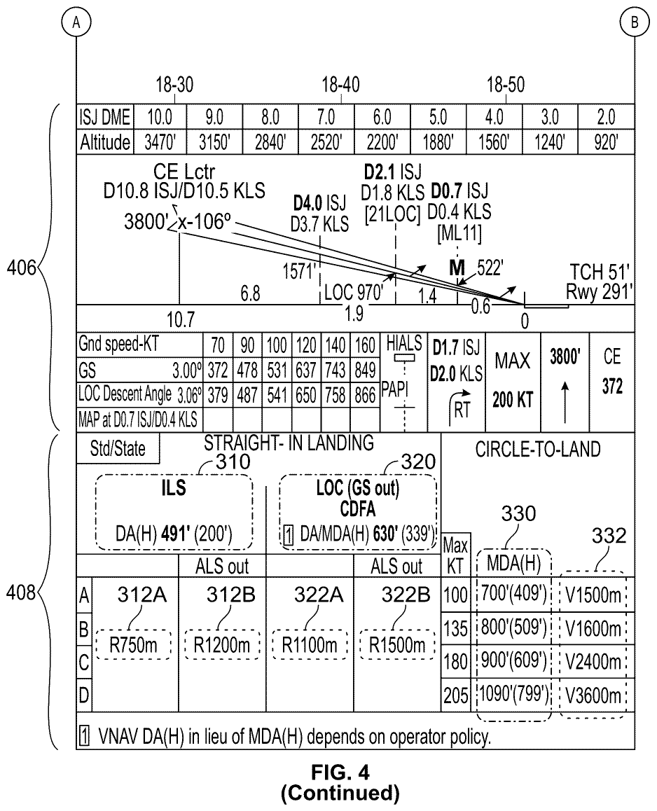

FIG. 4 illustrates a second graphical example of a display 400 of landing requirements, according to one example of the present disclosure. The landing requirements may be displayed to the operator of the system 100, such as via the I/O device 106. Optionally, the landing requirements may be displayed to the pilot of the aircraft system, to plural different pilots operating plural different aircraft systems, to an air-traffic control operator, or the like.

Like the display 300 illustrated in FIG. 3, the display 400 includes a minimum section 408 that displays the calculated minimum altitude landing requirements 310, 312, 332, as well as the corresponding determined minimum visibility requirements 312A, 312B, 322A, 322B, 332.

The display 400 also includes a text section 402 that includes textual details to be displayed to the pilot and/or operator. The text section 402 may include the first minimum altitude landing requirement 310 that indicates that the calculated minimum altitude for the type of aircraft system is 491 feet. The text section 402 may also include an approach course, a frequency bar specifying communication channels to communicate between the aircraft system and the landing location, a detailed description of a missed approach procedure, airport and/or runway elevation details, a compass indicative minimum safe altitudes, or the like.

The display 400 includes a plan view section 404 and a side view section 406. The plan view section 404 and the side view section 406 may provide an illustrative example of a landing procedure for the aircraft system at the landing location, including an initial approach fix location, a locator outer marker, descent angles and/or altitudes, circling locations and/or altitudes, wind speed, or the like. The displays 300 and 400 illustrated in FIGS. 3 and 4, respectively, are for illustrative purposes only, and may include additional and/or alternative information, the information may be arranged in an alternative arrangement or format, or the like.

The diagrams of examples herein may illustrate one or more control or processing units, such as the controller 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the controller 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In one or more examples, the controller 102 may represent and/or include an artificial intelligence (AI), machine learning (ML), artificial neural network (ANN), a recurrent neural network (RNN), a long short-term memory (LSTM) network, or the like, that can access data stored within the memory 108, within the memory 118 of the network control unit 116, within a memory of the remote database(s) 112, or the like, and that performs operations described herein. The AI system can assist the operator of the system 100, such as by automatically scanning for and detecting one or more changes that are made to the first set of data and/or the second set of data, by recommending that new landing requirements or revised landing requirements are calculated or determined, by changing an appearance of a display of the controller 102, or the like. For example, the AI system may present a recommendation to the operator to initiate that landing requirements should be calculated, should be re-calculated, or the like.

Referring to FIGS. 1-4, examples of the subject disclosure provide systems and methods that allow large amounts of data to be quickly and efficiently analyzed by a computing device. For example, the controller 102 can receive and analyze the hundreds, thousands, millions, or more data and/or records that may be in the form of different types of modalities. The controller 102 may also analyze the data associated with the real-time situational awareness of landing locations and/or the aircraft systems that are scheduled to land at corresponding landing locations to identify anomalies in existing landing requirements that may risk landing errors to occur. As such, large amounts of data, which may not be discernable by human beings, are being tracked and analyzed. The vast amounts of data are efficiently organized and/or analyzed by the controller 102, as described herein. The controller 102 analyzes the data in a relatively short time in order to quickly and efficiently determine landing requirements at which an aircraft system is to adhere in order to properly and safely land. A human being would be incapable of efficiently analyzing such vast amounts of data in such a short time. As such, examples of the present disclosure provide increased and efficient functionality, improved accuracy in the requirements that are calculated, reduce a number of errors relative to a human calculating the landing requirements, improved adaptability when faced with changes to regulatory requirements, concepts, and landing procedures, and vastly superior performance in relation to a human being analyzing the vast amounts of data.

In at least one example, components of the system 100, such as the controller 102, provide and/or enable a computer system to operate as a special computer system for examining data and calculating minimum landing requirements for aircraft systems. The controller 102 improves upon standard computing devices by monitoring real-time situational awareness conditions, automatically identifying changes to requirements and/or procedures, and calculating and communicating real-time and up-to-date landing requirements in an efficient and effective manner.

In at least one example, the processors 104 of the controller 102 can be an artificial intelligence or machine learning system. These types of systems may be trained from outside information and/or self-trained to repeatedly improve the accuracy with how data is analyzed. Over time, these systems can improve by determining such information with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data.

Based on this feedback, the systems may be trained by adjusting one or more parameters, weights, rules, criteria, or the like, used in the analysis of the same. This process can be performed using the data and ensemble data instead of training data, and may be repeated many times to repeatedly improve the monitoring and analyzing performed by the controller 102. The training minimizes conflicts and interference by performing an iterative training algorithm, in which the systems are retrained with an updated set of data (for example, data associated with user selections detected by the controller 102, associated with real-time conditions at the landing locations, etc.) and based on the feedback examined prior to the most recent training of the systems. This provides a robust analysis model that can better determine situational information in a cost effective and efficient manner.

Further, the disclosure comprises examples according to the following clauses:

Clause 1: a method for determining landing requirements for landing an aircraft system, the method comprising:

detecting a user selection by an operator, the user selection configured to identify a location where an aircraft system is configured to land, the user selection associated with a first set of data;

receiving the first set of data stored within a database;

accessing a second set of data from a network control unit, the second set of data including one or more regulatory requirements associated with the user selection;

analyzing the first set of data relative to the second set of data with one or more processors to determine one or more landing requirements for the aircraft system; and

transmitting the one or more landing requirements to the aircraft system, wherein the aircraft system is configured to be controlled to land at the location according to the one or more landing requirements.

Clause 2: the method of clause 1, wherein the one or more landing requirements include one or more of an altitude requirement or a visual requirement.

Clause 3: the method of clauses 1 or 2, wherein the user selection is based on a classification of the aircraft system.

Clause 4: the method of any of clauses 1-3, further comprising identifying that at least some information is missing from the first set of data;

receiving a third set of data responsive to identifying that at least some of the information is missing from the first set of data, wherein the third set of data is configured to be combined with the first set of data; and

determining the one or more landing requirements for the aircraft system based on the first set of data, the second set of data, and the third set of data.

Clause 5: the method of clause 4, wherein the third set of data is configured to be manually provided by the operator, and further comprising reviewing the third set of data by a different, second operator to determine a level of accuracy of the third set of data.

Clause 6: the method of clause 5, further comprising:

determining that the level of accuracy of the third set of data meets a designated threshold; and

providing the third set of data to the database responsive to determining that the level of accuracy of the third set of data meets the designated threshold, wherein the third set of data is configured to be stored within the database with the first set of data.

Clause 7: the method of any of clauses 1-6, further comprising:

determining that at least some information within the second set of data has changed;

analyzing the first set of data relative to a revised second set of data with the one or more processors responsive to determining that at least some of the information within the second set of data has changed;

determining one or more revised landing requirements for the aircraft system based on the first set of data and the revised second set of data; and

transmitting the one or more revised landing requirements to the aircraft system.

Clause 8: the method of any of clauses 1-8, further comprising:

automatically receiving a revised first set of data responsive to at least some of the information associated with the user selection changing; and

determining one or more revised landing requirements for the aircraft system based on the revised first set of data and the second set of data.

Clause 9: the method of clause 8, wherein the revised first set of data indicates one or more changes to a lighting system at the location the aircraft system is configured to land.

Clause 10: a system for determining landing requirements for an aircraft system, the system comprising:

an input device configured to receive a user selection by an operator, the user selection configured to identify a location where an aircraft system is configured to land, the user selection associated with a first set of data;

a memory configured to store the first set of data; and

a controller comprising one or more processors configured to receive the first set of data stored within a database, the controller configured to access a second set of data from a network control unit, the second set of data including one or more regulatory requirements associated with the user selection,

wherein the controller is configured to analyze the first set of data relative to the second set of data to determine one or more landing requirements for the aircraft system, and

wherein the controller is configured to prompt the transmission of the one or more landing requirements to the aircraft system, wherein the aircraft system is configured to be controlled to land at the location according to the one or more landing requirements.

Clause 11: the system of clause 10, wherein the one or more landing requirements include one or more of an altitude requirement or a visual requirement.

Clause 12: the system of clauses 10 or 11, wherein the user selection is based on a classification of the aircraft system.

Clause 13: he system of any of clauses 10-12, wherein the controller is configured to receive a third set of data responsive to identification that at least some information is missing from the first set of data, wherein the third set of data is configured to be combined with the first set of data.

Clause 14: the system of clause 13, wherein the controller is configured to determine the one or more landing requirements for the aircraft system based on the first set of data, the second set of data, and the third set of data.

Clause 15: the system of any of clauses 10-14, wherein the controller is configured to receive a revised second set of data responsive to at least some information within the second set of data changing,

wherein the controller is configured to analyze the first set of data relative to the revised second set of data to determine one or more revised landing requirements for the aircraft system based on the first set of data and the revised second set of data, and

wherein the controller is configured to prompt the transmission of the one or more revised landing requirements to the aircraft system.

Clause 16: the system of any of clauses 10-15, wherein the controller is configured to receive a revised first set of data responsive to at least some of the information associated with the user selection changing,

wherein the controller is configured to determine one or more revised landing requirements for the aircraft system based on the revised first set of data and the second set of data.

Clause 17: the system of clause 16, wherein the revised first set of data is configured to indicate one or more changes to a lighting system at the location the aircraft system is configured to land.

Clause 18: a non-transitory computer-readable storage medium comprising executable instructions that, in response to execution, cause one or more control units comprising one or more processors to perform the operations comprising:

detecting a user selection by an operator, the user selection configured to identify a location where an aircraft system is configured to land, the user selection associated with a first set of data;

receiving the first set of data stored within a database;

accessing a second set of data from a network control unit, the second set of data including one or more regulatory requirements associated with the user selection;

identifying that at least some information is missing from the first set of data;

receiving a third set of data responsive to identifying that at least some of the information is missing from the first set of data, wherein the third set of data is configured to be combined with the first set of data;

analyzing the first set of data relative to the second set of data and the third set of data with to determine one or more landing requirements for the aircraft system; and

transmitting the one or more landing requirements to the aircraft system, wherein the aircraft system is configured to be controlled to land at the location according to the one or more landing requirements.

Clause 19: the non-transitory computer-readable storage medium of clause 18, wherein the one or more processors to perform the operations comprising:

reviewing the third set of data to determine a level of accuracy of the third set of data;

determining that the level of accuracy of the third set of data meets a designated threshold; and

providing the third set of data to the database responsive to determining that the level of accuracy of the third set of data meets the designated threshold, wherein the third set of data is configured to be stored within the database with the first set of data.

Clause 20: the non-transitory computer-readable storage medium of clauses 18 or 19, wherein the one or more landing requirements include one or more of an altitude requirement or a visual requirement.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method for determining landing requirements for landing an aircraft system, the method comprising:
detecting a user selection by an operator, the user selection configured to identify a location where an aircraft system is configured to land, the user selection associated with a first set of data;
receiving the first set of data stored within a database;
accessing a second set of data, the second set of data including one or more regulatory requirements associated with the user selection;
analyzing the first set of data relative to the second set of data with one or more processors to determine one or more landing requirements for the aircraft system; and
transmitting the one or more landing requirements to the aircraft system, wherein the aircraft system is configured to be controlled to land at the location according to the one or more landing requirements.

2. The method of claim 1, wherein the one or more landing requirements include one or more of an altitude requirement or a visual requirement.

3. The method of claim 1, wherein the user selection is based on a classification of the aircraft system.

4. The method of claim 1, further comprising
identifying that at least some information is missing from the first set of data;
receiving a third set of data responsive to identifying that at least some of the information is missing from the first set of data, wherein the third set of data is configured to be combined with the first set of data; and
determining the one or more landing requirements for the aircraft system based on the first set of data, the second set of data, and the third set of data.

5. The method of claim 4, wherein the third set of data is configured to be manually provided by the operator, and further comprising reviewing the third set of data by a different, second operator to determine a level of accuracy of the third set of data.

6. The method of claim 5, further comprising:
determining that the level of accuracy of the third set of data meets a designated threshold; and
providing the third set of data to the database responsive to determining that the level of accuracy of the third set of data meets the designated threshold, wherein the third set of data is configured to be stored within the database with the first set of data.

7. The method of claim 1, further comprising:
determining that at least some information within the second set of data has changed;
analyzing the first set of data relative to a revised second set of data with the one or more processors responsive to determining that at least some of the information within the second set of data has changed;
determining one or more revised landing requirements for the aircraft system based on the first set of data and the revised second set of data; and
transmitting the one or more revised landing requirements to the aircraft system.

8. The method of claim 1, further comprising:
automatically receiving a revised first set of data responsive to at least some of the information associated with the user selection changing; and
determining one or more revised landing requirements for the aircraft system based on the revised first set of data and the second set of data.

9. The method of claim 8, wherein the revised first set of data indicates one or more changes to a lighting system at the location the aircraft system is configured to land.

10. A system for determining landing requirements for an aircraft system, the system comprising:
an input device configured to receive a user selection by an operator, the user selection configured to identify a location where an aircraft system is configured to land, the user selection associated with a first set of data;
a memory configured to store the first set of data; and
a controller comprising one or more processors configured to receive the first set of data stored within the memory, the controller configured to access a second set of data, the second set of data including one or more regulatory requirements associated with the user selection,
wherein the controller is configured to analyze the first set of data relative to the second set of data to determine one or more landing requirements for the aircraft system, and
wherein the controller is configured to prompt the transmission of the one or more landing requirements to the aircraft system, wherein the aircraft system is configured to be controlled to land at the location according to the one or more landing requirements.

11. The system of claim 10, wherein the one or more landing requirements include one or more of an altitude requirement or a visual requirement.

12. The system of claim 10, wherein the user selection is based on a classification of the aircraft system.

13. The system of claim 10, wherein the controller is configured to receive a third set of data responsive to identification that at least some information is missing from the first set of data, wherein the third set of data is configured to be combined with the first set of data.

14. The system of claim 13, wherein the controller is configured to determine the one or more landing requirements for the aircraft system based on the first set of data, the second set of data, and the third set of data.

15. The system of claim 10, wherein the controller is configured to receive a revised second set of data responsive to at least some information within the second set of data changing,
wherein the controller is configured to analyze the first set of data relative to the revised second set of data to determine one or more revised landing requirements for the aircraft system based on the first set of data and the revised second set of data, and
wherein the controller is configured to prompt the transmission of the one or more revised landing requirements to the aircraft system.

16. The system of claim 10, wherein the controller is configured to receive a revised first set of data responsive to at least some of the information associated with the user selection changing,
wherein the controller is configured to determine one or more revised landing requirements for the aircraft system based on the revised first set of data and the second set of data.

17. The system of claim 16, wherein the revised first set of data is configured to indicate one or more changes to a lighting system at the location the aircraft system is configured to land.

18. A non-transitory computer-readable storage medium comprising executable instructions that, in response to execution, cause one or more control units comprising one or more processors to perform the operations comprising:
detecting a user selection by an operator, the user selection configured to identify a location where an aircraft system is configured to land, the user selection associated with a first set of data;
receiving the first set of data stored within a database;
accessing a second set of data, the second set of data including one or more regulatory requirements associated with the user selection;
identifying that at least some information is missing from the first set of data;
receiving a third set of data responsive to identifying that at least some of the information is missing from the first set of data, wherein the third set of data is configured to be combined with the first set of data;
analyzing the first set of data relative to the second set of data and the third set of data with to determine one or more landing requirements for the aircraft system; and
transmitting the one or more landing requirements to the aircraft system, wherein the aircraft system is configured to be controlled to land at the location according to the one or more landing requirements.

19. The non-transitory computer-readable storage medium of claim 18, wherein the one or more processors to perform the operations comprising:
reviewing the third set of data to determine a level of accuracy of the third set of data;
determining that the level of accuracy of the third set of data meets a designated threshold; and
providing the third set of data to the database responsive to determining that the level of accuracy of the third set of data meets the designated threshold, wherein the third set of data is configured to be stored within the database with the first set of data.

20. The non-transitory computer-readable storage medium of claim 18, wherein the one or more landing requirements include one or more of an altitude requirement or a visual requirement.
